(19) United States
(12) Patent Application Publication
(10) Pub. No.: US 2018/0155541 A1
(43) Pub. Date: Jun. 7, 2018

(54) POLYMER RESINS WITH PHOSPHONATE OLIGOMERS

(71) Applicant: FRX POLYMERS, INC., Chelmsford, MA (US)

(72) Inventors: Jan-Pleun Lens, Boston, MA (US); Lawino Kagumba, Cambridge, MA (US); Morgan Pilkenton, Somerville, MA (US)

(21) Appl. No.: 15/820,155

(22) Filed: Nov. 21, 2017

Related U.S. Application Data
(60) Provisional application No. 62/424,758, filed on Nov. 21, 2016.

(51) Int. Cl. C08L 63/00; C08J 5/24; C09K 21/12

(52) U.S. Cl. CPC C08L 63/00; C08J 5/24; C09K 21/12; C08L 2205/03; C08J 2425/08; C08J 2433/00; C08J 2433/24; C08J 2363/00

(57) ABSTRACT

Embodiments described herein are directed to compositions comprising nitrogen containing SMA oligomers or polymers in combination with the phosphonate oligomers or polymers. These compositions may be combined with other polymer resins to produce polymer compositions having good electrical, thermal, and mechanical properties combined with flame retardancy.

### CROSS-REFERENCE TO RELATED APPLICATIONS

This application claims priority to U.S. Provisional Patent Application Ser. No. 62/424,758 filed Nov. 21, 2016, the entirety of which is incorporated herein by reference.

### GOVERNMENT INTERESTS

Not applicable

### PARTIES TO A JOINT RESEARCH AGREEMENT

Not applicable

### INCORPORATION BY REFERENCE OF MATERIAL SUBMITTED ON A COMPACT DISC

Not applicable

### BACKGROUND

The state-of-the-art approach to rendering polymers flame retardant is to use additives such as halogenated compounds (mainly bromine or chlorine containing), inorganic materials (such as, aluminum trihydrate), and/or nitrogen or phosphorus containing compounds. Some halogenated compounds are toxic, persistent, and bioaccumulate. Moreover, these compounds typically have low molecular weights and can leach into the environment over time, which makes their use less desirable. In some countries, certain halogenated additives are being phased-out of use because of these environmental concerns.

More and better ways of rendering polymers flame retardant are therefore needed. This application discloses compositions and methods of doing just that.

### SUMMARY

Some embodiments provide a composition comprising a polymer resin; a styrenic maleic anhydride copolymer, and a phosphonate oligomer or polymer.

In some embodiments, the polymer resin is an epoxy resin, a cyanate ester resin, a benzoxazine resin or a polyarylene ether resin.

In some embodiments, the styrenic maleic anhydride copolymer comprises an imidized-styrenic maleic anhydride copolymer.

In some embodiments, the styrenic maleic anhydride copolymer comprises an imidized-SMA of general Formula I:

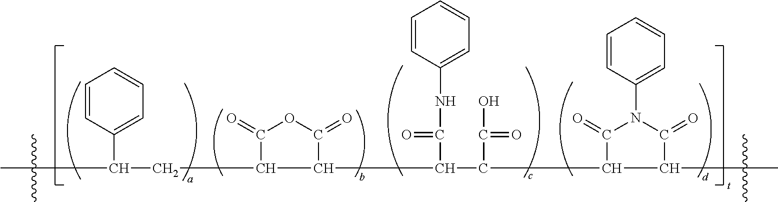

where a, b, c, and d are each individually integers of 0 to 5, and t is an integer of 2 to 100. In some embodiments one or more of a, b, or c may be absent. In some embodiments, a is 1 or 2, b is 0, c is 0, and d is 1. In some embodiments, a is 1 or 2, b is 1, c is 1, and d is 1. In some embodiments, Monomers b, c, and d may be in any order.

In some embodiments, the styrene-maleic anhydride copolymer comprises a maleic anhydride group content of about 0% to about 50% (0 to 0.5 mole fraction of maleic anhydride).

In some embodiments, the styrene-maleic anhydride copolymer comprises from 0% to 100% imidized maleic anhydride groups. In some embodiments, Nitrogen content in the imidized styrenic maleic anhydride copolymer ranges from 0.1 wt % to 10 wt %. In some embodiments, the nitrogen content of the styrenic maleic anhydride copolymer ranges from 1.5 wt % to 2.5%.

Some embodiments provide a hardener system comprising at least a styrenic-maleic anhydride component and a phosphonate component. In some embodiments, the styrenic maleic anhydride copolymer comprises an imidized-styrenic maleic anhydride copolymer. In some embodiments, the styrenic maleic anhydride copolymer comprises imidized-SMA of general Formula I:

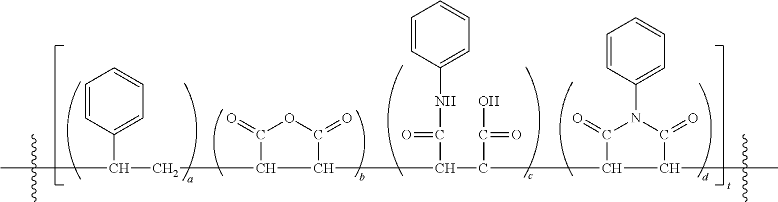

where a, b, c, and d are each individually integers of 0 to 5, and t is an integer of 2 to 100. In some embodiments one or more of a, b, or c may be absent. In some embodiments, a is 1 or 2, b is 0, c is 0, and d is 1. In some embodiments, a is 1 or 2, b is 1, c is 1, and d is 1. In some embodiments, Monomers b, c, and d may be in any order.

In some embodiments, the styrene-maleic anhydride copolymer comprises a maleic anhydride group content of about 0% to about 50% (0 to 0.5 mole fraction of maleic anhydride).

In some embodiments, the styrene-maleic anhydride copolymer comprises from 0% to 100% imidized maleic anhydride groups. In some embodiments, Nitrogen content in the imidized styrenic maleic anhydride copolymer ranges from 0.1 wt % to 10 wt %. In some embodiments, the nitrogen content of the styrenic maleic anhydride copolymer ranges from 1.5 wt % to 2.5%.

Some embodiments provide a prepreg comprising of reinforcing material where the composition according to claim 1 is applied to the prepreg and cured.

Some embodiments provide a laminate comprising of one or more such prepregs.

### DESCRIPTION OF DRAWING

FIG. 1 is a graph summarizing the vertical burn tests of the range of P-N contents shown in Table II and III.

### DETAILED DESCRIPTION

The above summary of the present invention is not intended to describe each illustrated embodiment or every possible implementation of the present invention. The detailed description, which follows, particularly exemplifies these embodiments.

Before the present compositions and methods are described, it is to be understood that they are not limited to the particular compositions, methodologies or protocols described, as these may vary. It is also to be understood that the terminology used in the description is for the purpose of describing the particular versions or embodiments only, and is not intended to limit their scope which will be limited only by the appended claims.

It must also be noted that as used herein and in the appended claims, the singular forms “a”, “an”, and “the” include plural reference unless the context clearly dictates otherwise. Unless defined otherwise, all technical and scientific terms used herein have the same meanings as commonly understood by one of ordinary skill in the art. Although any methods and materials similar or equivalent to those described herein can be used in the practice or testing of embodiments disclosed, the preferred methods, devices, and materials are now described.

“Optional” or “optionally” means that the subsequently described event or circumstance may or may not occur, and that the description includes instances where the event occurs and instances where it does not.

“Substantially no” means that the subsequently described event may occur at most about less than 10% of the time or the subsequently described component may be at most about less than 10% of the total composition, in some embodiments, and in others, at most about less than 5%, and in still others at most about less than 1%.

The term “carbonate” as used herein is given its customary meaning, e.g., a salt of carbonic acid containing the divalent, negative radical CO or an uncharged ester of this acid. A “diaryl carbonate” is a carbonate with at least two aryl groups associated with the CO radical, the most predominant example of a diaryl carbonate is diphenyl carbonate; however, the definition of diaryl carbonate is not limited to this specific example.

The term “aromatic dihydroxide” is meant to encompass any aromatic compound with at least two associated hydroxyl substitutions. Examples of “aromatic hydroxides” include but are not limited to benzene diols such as hydroquinone and any bisphenol or bisphenol containing compounds.

The term “alkyl” or “alkyl group” refers to a branched or unbranched hydrocarbon or group of 1 to 20 carbon atoms, such as but not limited to methyl, ethyl, n-propyl, isopropyl, n-butyl, isobutyl, t-butyl, octyl, decyl, tetradecyl, hexadecyl, eicosyl, tetracosyl and the like. “Cycloalkyl” or “cycloalkyl groups” are branched or unbranched hydrocarbons in which all or some of the carbons are arranged in a ring such as but not limited to cyclopentyl, cyclohexyl, methylcyclohexyl and the like. The term “lower alkyl” includes an alkyl group of 1 to 10 carbon atoms.

The term “aryl” or “aryl group” refers to monovalent aromatic hydrocarbon radicals or groups consisting of one or more fused rings in which at least one ring is aromatic in nature. Aryls may include but are not limited to phenyl, napthyl, biphenyl ring systems and the like. The aryl group may be unsubstituted or substituted with a variety of substituents including but not limited to alkyl, alkenyl, halide, benzylic, alkyl or aromatic ether, nitro, cyano and the like and combinations thereof.

“Substituent” refers to a molecular group that replaces a hydrogen in a compound and may include but are not limited to trifluoromethyl, nitro, cyano, C1-C20 alkyl, aromatic or aryl, halide (F, Cl, Br, I), C1-C20 alkyl ether, C1-C20 alkyl ester, benzyl halide, benzyl ether, aromatic or aryl ether, hydroxy, alkoxy, amino, alkylamino (—NHR′), dialkylamino (—NR′R″) or other groups which do not interfere with the formation of the diaryl alkylphosphonate.

As defined herein, an “arylol” or an “arylol group” is an aryl group with a hydroxyl, OH, group substituent on the aryl ring. Non-limiting examples of an arylol are phenol, naphthol, and the like. A wide variety of arlyols may be used in the embodiments of the invention and are commercially available.

The term “alkanol” or “alkanol group” refers to a compound including an alkyl of 1 to 20 carbon atoms or more having at least one hydroxyl group substituent. Examples of alkanols include but are not limited to methanol, ethanol, 1- and 2-propanol, 1,1-dimethylethanol, hexanol, octanol and the like. Alkanol groups may be optionally substituted with substituents as described above.

The term “alkenol” or “alkenol group” refers to a compound including an alkene 2 to 20 carbon atoms or more having at least one hydroxyl group substituent. The hydroxyl may be arranged in either isomeric configuration (cis or trans). Alkenols may be further substituted with one or more substituents as described above and may be used in place of alkanols in some embodiments of the invention. Alkenols are known to those skilled in the art and many are readily available commercially.

The terms “flame retardant,” “flame resistant,” “fire resistant,” or “fire resistance,” as used herein, means that the composition exhibits a limiting oxygen index (LOI) of at least 27. “Flame retardant,” “flame resistant,” “fire resistant,” or “fire resistance,” may also be tested by measuring the after-burning time in accordance with the UL test (Subject 94). In this test, the tested materials are given classifications of UL-94 V-0, UL-94 V-1 and UL-94 V-2 on the basis of the results obtained with the ten test specimens. Briefly, the criteria for each of these UL-94-V-classifications are as follows:

UL-94 V-0: the total flaming combustion for each specimen after removal of the ignition flame should not exceed 10 seconds and the total flaming combustion for 5 specimens should not exceed 50 seconds. None of the test specimens should release and drips which ignite absorbent cotton wool.

UL-94 V-1: the total flaming combustion for each specimen after removal of the ignition flame should not exceed 30 seconds and the total flaming combustion for 5 specimens should not exceed 250 seconds. None of the test specimens should release any drips which ignite absorbent cotton wool.

UL-94 V-2: the total flaming combustion for each specimen after removal of the ignition flame should not exceed 30 seconds and the total flaming combustion for 5 specimens should not exceed 250 seconds. Test specimens may release flaming particles, which ignite absorbent cotton wool.

Fire resistance may also be tested by measuring after-burning time. These test methods provide a laboratory test procedure for measuring and comparing the surface flammability of materials when exposed to a prescribed level of radiant heat energy to measure the surface flammability of materials when exposed to fire. The test is conducted using small specimens that are representative, to the extent possible, of the material or assembly being evaluated. The rate at which flames travel along surfaces depends upon the physical and thermal properties of the material, product or assembly under test, the specimen mounting method and orientation, the type and level of fire or heat exposure, the availability of air, and properties of the surrounding enclosure. If different test conditions are substituted or the end-use conditions are changed, it may not always be possible by or from this test to predict changes in the fire-test-response characteristics measured. Therefore, the results are valid only for the fire test exposure conditions described in this procedure.

The state-of-the-art approach to rendering polymers flame retardant is to use additives such as brominated compounds or compounds containing aluminum and/or phosphorus. Use of the additives with polymer can have a deleterious effect on the processing characteristics and/or the mechanical performance of articles produced from them. In addition, some of these compounds are toxic, and can leach into the environment over time making their use less desirable. In some countries, certain brominated additives are being phased-out of use because of environmental concerns.

“Molecular weight,” as used herein, can be determined by relative viscosity (ηrel) and/or gel permeation chromatography (GPC). “Relative viscosity” of a polymer is measured by dissolving a known quantity of polymer in a solvent and comparing the time it takes for this solution and the neat solvent to travel through a specially designed capillary (viscometer) at a constant temperature. Relative viscosity is a measurement that is indicative of the molecular weight of a polymer. It is also well known that a reduction in relative viscosity is indicative of a reduction in molecular weight, and reduction in molecular weight causes loss of mechanical properties such as strength and toughness. GPC provides information about the molecular weight and molecular weight distribution of a polymer. It is known that the molecular weight distribution of a polymer is important to properties such as thermo-oxidative stability, toughness, melt flow, and fire resistance, for example, low molecular weight polymers drip more when burned.

Embodiments of the invention are directed to polymer compositions including a styrenic maleic anhydride (copolymer) component, a polymer resin such as epoxy, and a phosphonate component, and copper clad laminates (CCL) and prepregs including these compositions. Further embodiments are directed to methods for making these compositions, CCLs, and prepregs, and articles of manufacture containing these compositions, CCLs, and prepregs.

The compositions of embodiments may contain any polymer resin known in the art. In particular embodiments, the polymer resin may be an epoxy resin, and in certain embodiments, the resin may contain glycidyl groups, alicyclic epoxy groups, oxirane groups, ethoxyline groups, or similar epoxy groups or combinations thereof that can react with epoxy groups associated with the epoxy containing phosphonate polymers, copolymers, oligomers and co-oligomers of this invention. Such epoxy resins are well known in the art and include, but are not limited to, novolac-type epoxy resin, cresol-novolac epoxy resin, triphenolalkane-type epoxy resin, aralkyl-type epoxy resin, aralkyl-type epoxy resin having a biphenyl skeleton, biphenyl-type epoxy resin, dicyclopentadiene-type epoxy resin, heterocyclic-type epoxy resin, epoxy resin containing a naphthalene ring, a bisphenol-A type epoxy compound, a bisphenol-F type epoxy compound, stilbene-type epoxy resin, trimethylol-propane type epoxy resin, terpene-modified epoxy resin, linear aliphatic epoxy resin obtained by oxidizing olefin bonds with peracetic acid or a similar peracid, alicyclic epoxy resin, or sulfur-containing epoxy resin. In some embodiments, the epoxy resin may be composed of two or more epoxy resins of any of the aforementioned types. In particular embodiments, the epoxy resins may be aralkyl-type epoxy resins, such as epoxy resins derived from bisphenol A or 4,4′-methylene dianiline. The epoxy may also contain one or more additional components such as, for example, a benzoxazine compound or resin, and in some embodiments, the novel epoxy containing phosphonate monomers, polymers, copolymers, oligomers and co-oligomers may be used as epoxy modifiers, chain extenders or crosslinkers for epoxy resins, or epoxy hardeners in such epoxy resin polymer compositions.

In some embodiments, the polymer resin may be a cyanate ester resin. Such resins are known in the art and can include any resin having units of —OCN. In certain embodiments, the cyanate esters may contain units of Ar—O—CN, where Ar is substituted or unsubstituted benzene, biphenyl, naphthalene, phenol novolac, bisphenol A, bisphenol A novolac, bisphenol F, bisphenol F novolac, or phenolphthalein, and in some embodiments Ar may be bonded with substituted or unsubstituted dicyclopentadienyl. Examples of cyanate ester resins include, but are not limited to:

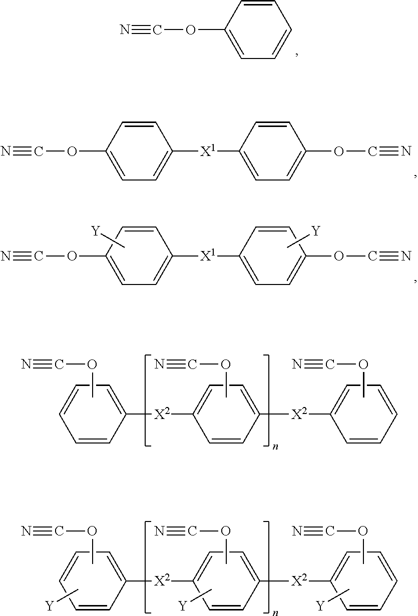

where each X¹ and X² are independently —C(CH₃)₂—, —CH(CH₃)—, —CH₂—, SO₂, O, substituted or unsubstituted benzene, biphenyl, naphthalene, phenol novolac, bisphenol A, ester, ring-substituted fluorenones, hydrogenated bisphenol A, bisphenol A novolac, bisphenol F, or bisphenol F novolac function groups; n is an integer equal to 1 to 100; and Y is C₁₋₂₀ alkyl, C₂₋₂₀ alkene, C₂₋₂₀ alkyne, C₅₋₂₀ cycloalkyl, or C₆₋₂₀ aryl.

In some embodiments, the polymer resin may be a benzoxazine resin. Such resins are known in the art and can include bisphenol A benzoxazine, bisphenol F benzoxazine, phenolphthalein benzoxazine, and the like and combinations thereof. Examples of benzoxazine resins include, but are not limited to:

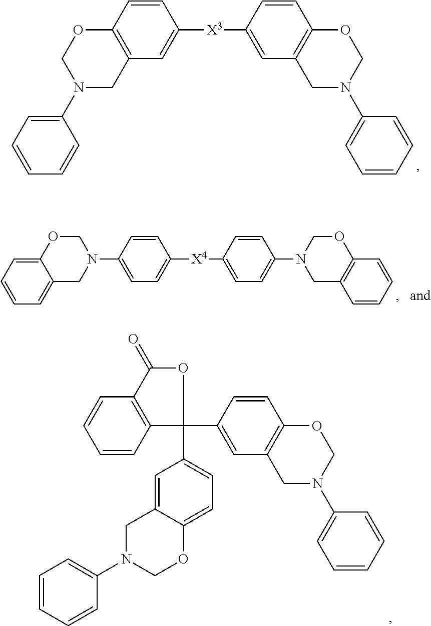

wherein each X³ and X⁴ are independently —C(CH₃)₂—, —CH(CH₃)—, —CH₂—, SO₂, O, substituted or unsubstituted benzene, biphenyl, naphthalene, phenol novolac, bisphenol A, ester, ring-substituted fluorenones, hydrogenated bisphenol A, bisphenol A novolac, bisphenol F, or bisphenol F novolac.

In particular embodiments, the polymer resin may be a poly(arylene ether)s ether such as polyphenylene ether or polyphenylene oxide polymers or oligomers. The styrene-maleic anhydride copolymer and the phosphonate component, together comprise a hardener or hardening system. The styrene-maleic anhydride copolymer may be imidized.

The styrenic component of various embodiments may include styrene copolymers or oligomers having repeating units of styrene (C₆H₅CH═CH₂), styrene derivatives, or combinations thereof and maleic anhydride. Styrene derivatives include, for example, substituted styrene such as o-methylstyrene, p-methylstyrene, p-tert-butylstyrene, and α-methyl styrene. Maleic anhydride includes maleic anhydride (C₂H₂(CO)₂O), similar compounds where maleic anhydride is modified to maleic imides, maleic amic acid or maleic esters, for example, maleimide, N-phenyl maleimide, N-benzyl maleimide, N-cyclohexyl maleimide, maleic amic acid and alkyl ester of maleic acid mixtures thereof. The molecular weight of the styrenic maleic anhydride copolymers can range from low molecular weight oligomers 1000-10000 g/mol to high Mw polymers >10,000 to 300,000. Commercial examples of such styrene and maleic anhydride copolymers include, but are not limited to, SMA EF −40, SMA EF −60 and SMA EF −80 all of which are available from Sartomer Company, Inc., and SMA EF −100, which is available from Elf Atochem, Inc. and XIRAN® styrene maleic anhydride copolymers available from Polyscope. In particular embodiments, the styrenic component may be methacrylate-butadiene-styrene (MBS).

In certain embodiments, the maleic anhydride component of the styrenic copolymer can be imidized-SMA (i-SMA). SMA can be imidized with primary amines or ammonia. For example, SMA can be imidized according to following reaction:

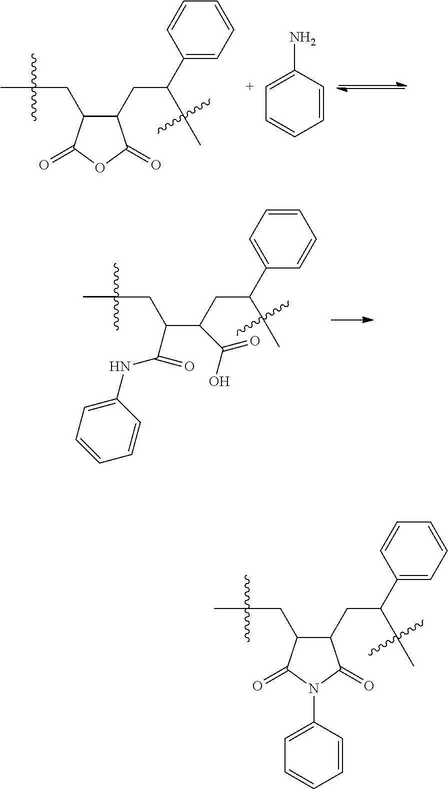 [SMILES: *CC1C(=O)OC(=O)C1CC(*)c1ccccc1 ; NC1=[C+]C=CC=C1 ; *CC(C(=O)Nc1ccccc1)C(CC(*)c1ccccc1)C(=O)O ; *CC1C(=O)N(c2ccccc2)C(=O)C1CC(*)c1ccccc1]

Although the imidization provided above was carried out with aniline (C₆H₅NH₂), imidization can be carried out with any amine containing compound. In particular embodiments, the imidized-SMA can be of general Formula I:

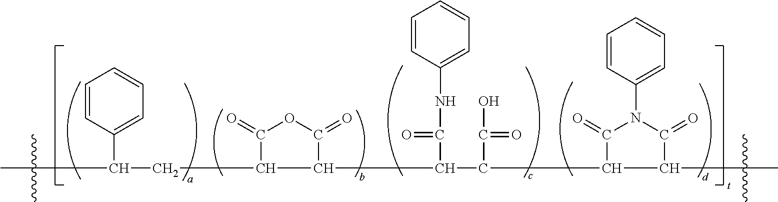

where a, b, c, and d are each individually integers of 0 to 5, and t is an integer of 2 to 100. In some embodiments, one or more of monomer a, monomer b, or monomer c may be absent in a repeating unit t. For example, in certain embodiments, a may be 1 or 2, b may be 0, c may be 0, and d may be 1, and in another example embodiments, a may be 1 or 2, b may be 1, c may be 1, and d may be 1. Monomers b, c, and d may be in any order. For example, in some embodiments, the order of monomers may be a-d-b or a-c-b. In some embodiments, the content of maleic anhydride groups in the styrenic copolymer range from 0% to 50% (0 to 0.5 mole fraction of maleic anhydride). The level of imidization of the maleic anhydride groups in the styrenic copolymer can range from 0% to 100%. The level of imidization can be checked by measuring the nitrogen content using the Kjeldahl method, ISO 5663. Nitrogen content in the imidized styrenic copolymer ranges from 0.1 wt % to 10 wt %. In specific embodiments the nitrogen content of the styrenic copolymer ranged from 1.5 wt % to 2.5%.

The phosphonate component of such embodiments may be oligomeric or polymeric linear or branched phosphonates, random or block co-(phosphonate ester)s, and random or block co-(phosphonate carbonate)s, and in certain embodiments, the phosphonate component may be hyperbranched oligomeric phosphonates. In some embodiments, the phosphonate component may have reactive end groups, such as hydroxyl, epoxy, vinyl, vinyl ester, isopropenyl, isocyanate, or combinations thereof, and in other embodiments, greater than 90% of the total termini of the polymeric or oligomeric phosphonate may have a non-reactive end group.

For simplicity, throughout this disclosure, the term “oligomer” or “oligomeric” are to be construed as referring compound having less than 20 repeating units. The oligomers described herein can include oligophosphonates, random or block co-oligo(phosphonate ester)s, and random or block co-oligo(phosphonate carbonate)s. Such oligomers encompassed by these terms can be linear, lightly branched, indicating a relatively small number of branches, for example, 1 to about 5 branches per oligomer, or hyperbranched, indicating a relatively high number of branches, for example, greater than 5. While individual types of oligomers may be called out in specific exemplary embodiments, any oligomeric phosphonate described herein can be used in such exemplary embodiments. For example, an exemplary stating that an oligomeric phosphonate is used can be carried out with a linear, lightly branched, or hyperbranched oligomeric phosphonate that can be an oligophosphonate, random or block co-oligo(phosphonate ester), and random or block co-oligo(phosphonate carbonate) type oligomeric phosphonate.

Embodiments of the invention are not limited by the type of oligomeric or polymeric phosphonate, co-(phosphonate ester), or co-(phosphonate carbonate), and in certain embodiments, the oligomeric or polymeric phosphonate, co-(phosphonate ester), or co-(phosphonate carbonate) may have the structures described and claimed in U.S. Pat. Nos. 6,861,499, 7,816,486, 7,645,850, and 7,838,604 and U.S. Publication No. 2009/0032770, each of which are hereby incorporated by reference in their entireties. Such oligomers and polymers may include repeating units derived from diaryl alkylphosphonates or diaryl arylphosphonates. For example, in some embodiments, such phosphonate oligomers and polymers include structural units illustrated by Formula II:

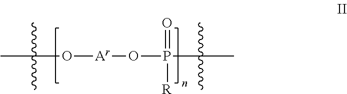

where Ar is an aromatic group and —O—Ar—O— may be derived from a dihydroxy compound having one or more, optionally substituted, aryl rings such as, but not limited to, resorcinols, hydroquinones, and bisphenols, such as bisphenol A, bisphenol F, and 4,4′-biphenol, phenolphthalein, 4,4′-thiodiphenol, 4,4′-sulfonyldiphenol, 3,3,5-trimethylcyclohexyldiphenol, or combinations of these, R is a C₁₋₂₀ alkyl, C₂₋₂₀ alkene, C₂₋₂₀ alkyne, C₅₋₂₀ cycloalkyl, or C₆₋₂₀ aryl, and n is an integer from 1 to about 20, 1 to about 10, or 2 to about 5, or any integer between these ranges.

In other embodiments, the co-(phosphonate carbonate), or co-(phosphonate ester), may have structures such as, but not limited to, those structures of Formulae III and IV, respectively:

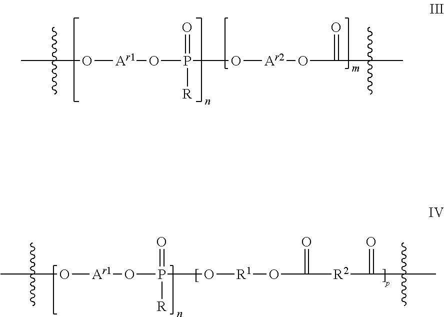

and combinations thereof, where Ar, Ar¹, and Ar² are each, independently, an aromatic group and —O—Ar—O— may be derived from a dihydroxy compound having one or more, optionally substituted aryl rings such as, but not limited to, resorcinols, hydroquinones, and bisphenols, such as bisphenol A, bisphenol F, and 4,4′-biphenol, phenolphthalein, 4,4′-thiodiphenol, 4,4′-sulfonyldiphenol, 3,3,5-trimethylcyclohexyldiphenol, or combinations of these, R is a C₁₋₂₀ alkyl, C₂₋₂₀ alkene, C₂₋₂₀ alkyne, C₅₋₂₀ cycloalkyl, or C₆₋₂₀ aryl, R¹ and R² are aliphatic or aromatic hydrocarbons, and each m, n, and p can be the same or different and can, independently, be an integer from 1 to about 20, 1 to about 10, or 2 to about 5, or any integer between these ranges. In certain embodiments, each m, n and p are about equal and generally greater than 5 or less than 15.

As indicated by the term “random” the monomers of the oligomeric or polymeric “random co-(phosphonate carbonate)s” or “random co-(phosphonate ester)s of various embodiments are incorporated into polymer chain randomly, such that the phosphonate chain can include alternating phosphonate and carbonate or ester monomers or short segments in which several phosphonate or carbonate or ester monomers are linked by an aromatic dihydroxide. The length of such segments may vary within individual random co-(phosphonate carbonate)s or co-(phosphonate ester).

In particular embodiments, the Ar, Ar¹, and Ar² may be bisphenol A and R may be a methyl group providing phosphonates having reactive end-groups including random and block co-(phosphonate carbonate)s and co-(phosphonate ester)s. Such compounds may have structures such as, but not limited to, structures of Formulae V, VI, and VII:

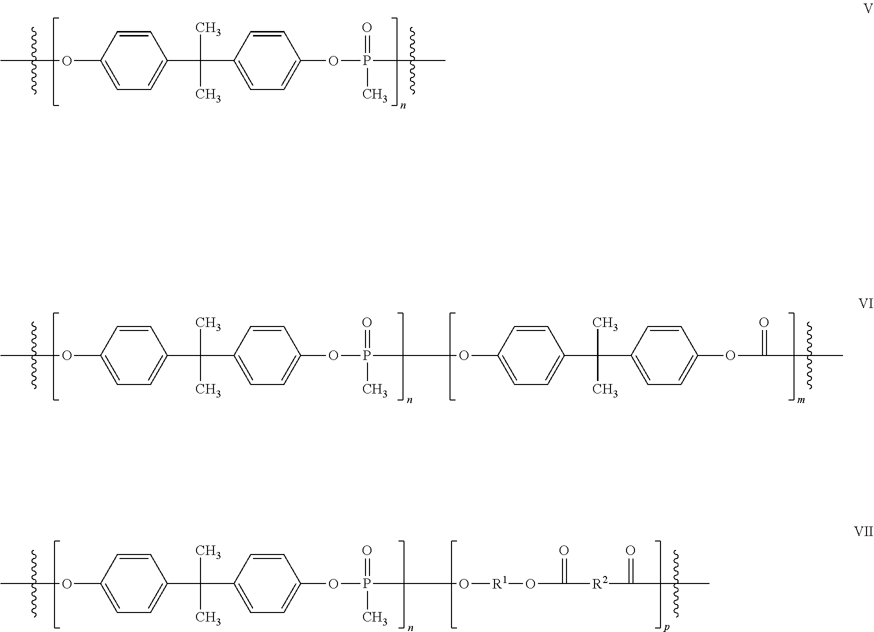

and combinations thereof, where each of m, n, p, and R¹ and R² are defined as described above. Such co-(phosphonate ester), or co-(phosphonate carbonate) may be block co-(phosphonate ester), block co-(phosphonate carbonate) in which each m, n, and p is greater than about 1, and the co-oligomers and copolymers contain distinct repeating phosphonate and carbonate blocks or phosphonate and ester blocks. In other embodiments, the oligomeric and polymeric co-(phosphonate ester) or co-(phosphonate carbonate) can be random copolymers in which each m, n, and p can vary and may be from n is an integer from 1 to about 20, 1 to about 10, or 2 to about 5, where the total of m, n, and p is an integer from 1 to about 20, 1 to about 10, or 2 to about 5 or any integer between these ranges.

With particular regard to co-(phosphonate ester)s, co-(phosphonate carbonate)s, block co-(phosphonate ester)s, and block co-(phosphonate carbonate)s, without wishing to be bound by theory, oligomers and polymers containing carbonate components, whether as carbonate blocks or randomly arranged carbonate monomers, may provide improved toughness over oligomers or polymers derived solely from phosphonates. Such co-oligomers and copolymers may also provide higher glass transition temperature, Tg, and better heat stability over phosphonate oligomers and polymers.

The phosphonate and carbonate content of the oligomeric and polymeric phosphonates, random or block co-(phosphonate carbonate)s and co-(phosphonate ester)s may vary among embodiments, and embodiments are not limited by the phosphonate and/or carbonate content or range of phosphonate and/or carbonate content. For example, in some embodiments, the co-(phosphonate carbonate)s or co-(phosphonate ester)s may have a phosphorus content, of from about 1% to about 20% by weight of the total oligomer or polymer, and in other embodiments, the phosphorous content may be from about 2% to about 12% by weight of the total oligomer or polymer or about 2% to about 10% by weight of the total oligomer or polymer.

In some embodiments, the molecular weight (weight average molecular weight as determined by gel permeation chromatography based on polystyrene calibration) range of the oligophosphonates, random or block co-oligo(phosphonate ester)s and co-oligo(phosphonate carbonate)s may be from about 500 g/mole to about 18,000 g/mole or any value within this range. In other embodiments, the molecular weight range may be from about 1500 g/mole to about 15,000 g/mole, about 3000 g/mole to about 10,000 g/mole, or any value within these ranges. In still other embodiments, the molecular weight range may be from about 700 g/mole to about 9000 g/mole, about 1000 g/mole to about 8000 g/mole, about 3000 g/mole to about 4000 g/mole, or any value within these ranges.

The phosphonates of various embodiments including linear and branched oligophosphonates can exhibit a high molecular weight and/or a narrow molecular weight distribution (i.e., low polydispersity). For example, in some embodiments, the oligomeric phosphonates may have a weight average molecular weight (Mw) of about 1,000 g/mole to about 18,000 g/mole as determined by ηrel or GPC, and in other embodiments, the oligomeric phosphonates may have a Mw of from about 1,000 to about 15,000 g/mole as determined by ηrel or GPC. The number average molecular weight (Mn), in such embodiments, may be from about 1,000 g/mole to about 10,000 g/mole, or from about 1,000 g/mole to about 5,000 g/mole, and in certain embodiments the Mn may be greater than about 1,200 g/mole. The narrow molecular weight distribution (i.e., Mw/Mn) of such oligomeric phosphonates may be from about 1 to about 7 in some embodiments and from about 1 to about 5 in other embodiments. In still other embodiments, the co-oligo(phosphonate carbonate)s may have a relative viscosity (ηrel) of from about 1.01 to about 1.20. Without wishing to be bound by theory, the relatively high molecular weight and narrow molecular weight distribution of the oligomeric phosphonates of the invention may impart a superior combination of properties. For example, the oligomeric phosphonates of embodiments are extremely flame retardant and exhibit superior hydrolytic stability and can impart such characteristics on a polymer combined with the oligomeric phosphonates to produce polymer compositions such as those described below. In addition, the oligomeric phosphonates of embodiments, generally, exhibit an excellent combination of processing characteristics including, for example, good thermal and mechanical properties.

The polymer compositions of various embodiments may include a polymer resin and sufficient styrenic component and a phosphonate component to provide good physical properties and flame retardancy. For example, in some embodiments, the compositions may include about 15 wt. % to about 40 wt. % styrenic component and about 15 wt. % to about 40 wt. % phosphonate component, and in certain embodiments, the compositions may include about 15 wt. % to about 30 wt. % styrenic component and about 20 wt. % to about 30 wt. % phosphonate component or any individual value or range encompassed by these example ranges. Based on these hardener compositions, the polymer compositions may include about 0.2% to about 1.0% nitrogen from the styrenic component and about 1.5% to about 3.0% phosphorous from the phosphorous component. Such compositions may generally exhibit a UL94 rating V0 at 4 mm or lower and a glass transition temperature (Tg) of about 150° C. to about 200° C. Some embodiments further include a hardener which is complementary to the resin used (e.g. phenolic resins and phenolic hardeners). In some embodiments, the additional hardeners are phenolic hardeners, phenolic novalac hardeners, alkyl phenol novolac hardeners may be used.

The polymer compositions of various embodiments may further exhibit low dielectric constant (Dk) and low dielectric dissipation factor (Df). For example, in some embodiments, the compositions described above having a polymer resin and a hardener containing at least a styrenic component and a phosphonate component may exhibit a Dk of less than about 4 and a Df of less than about 0.01 at 10 gigahertz (GHz). In other embodiments, the compositions described above may exhibit a Dk of about 0.5 to about 4.0, about 1.0 to about 3.5, or about 1.5 to about 3.5 at 10 GHz or any individual value or range encompassed by these example ranges and a Df of about 0.0001 to about 0.01 or about 0.0005 to about 0.005 at 10 GHz or any individual value or range encompassed by these example ranges. In particular embodiments, the polymer compositions described above may have a combination of both low Dk and low Df as indicated by these example ranges, and in some embodiments, the polymer compositions may exhibit one of a low Dk or a low Df.

The compositions described above may include additional components such as additives, inorganic fillers such as silica or alumina trihydrate (ATH), metallic sheets or foils, and fibers, such as, but not limited to, chopped or continuous glass fiber, metal fibers, aramid fibers, carbon fibers, or ceramic fibers, surfactants, organic binders, polymeric binders, crosslinking agents, diluents, coupling agents, flame retardant agents, anti-dripping agents such as fluorinated polyolefins, silicones, and, lubricants, mould release agents such as pentaerythritol tetrastearate, nucleating agents, anti-static agents such as conductive blacks, carbon nanotubes, graphite, graphene, oxidized graphene, and organic antistatics such as polyalkylene ethers, alkylsulfonates, perfluoro sulfonic acid, perfluorobutane, sulfonic acid potassium salt, and polyamide-containing polymers, catalysts, colorants, inks, dyes, antioxidants, stabilizers, and the like and any combinations thereof.

In such embodiments, the each of the additional components or additives may make up from about 0.001 wt. % to about 1 wt. %, about 0.005 wt. % to about 0.9 wt. %, about 0.005 wt. % to about 0.8 wt. %, or about 0.04 wt. % to about 0.8 wt. % of the total composition, and in particular embodiments, the additional components or additives may make up about 0.04 wt. % to about 0.6 wt. % based on the total composition. Additional components such as glass fiber, carbon fiber, organic fiber, ceramic fiber or other inorganic fillers may be provided at much concentrations up to 70 volume (vol.) %. For example, the polymer compositions of certain embodiments may include about 5 vol. % to about 70 vol. %, from about 10 vol. % to about 60 vol. %, or about 20 vol. % to about 50 vol. % glass fiber, carbon fiber, organic fiber, or ceramic fiber.

Polymer compositions described above including a polymer resin and sufficient styrenic component and a phosphonate component can be prepared by conventional means. For example, in some embodiments, the compositions may be prepared by dissolving a polymer resin, styrenic component, and a phosphonate in a solvent to prepare a reaction mixture and removing the solvent from the reaction mixture. In such embodiments, the reaction mixture may be stirred for sufficient time to allow the various components to dissolve completely. For example, in some embodiments, the reaction mixture may be stirred for about 10 to about 20 hours or any time period or range encompassed by this example range. The step of removing the solvent can be carried out by any means. For example, in some embodiments, the step of removing the solvent can be carried out at room temperature or by gently heating the reaction mixture for sufficient time to allow the solvent to completely evaporate from the reaction mixture. In particular embodiments, removing the solvent can be carried out at a temperature of 30° C. to 175° C., about 40° C. to about 150° C., or about 50° C. to about 100° C.

In certain embodiments, the method may further include the step of curing the reaction mixture after removing the solvent. The resin mixture can be poured into a mold or coated onto glass fabric, several layers of which are layered together under a hot press to make laminates. Curing can be carried out by conventional means such as, for example, heating the resin mixture to a temperature of about 100° C. to about 250° C. or about 150° C. to about 200° C. for about 40 minutes to about 240 minutes, about 40 minutes to about 200 minutes, or about 60 minutes to about 180 minutes or any individual time period or range encompassed by this time period.

The solvent of used to dissolve the reaction mixture may be any solvent known in the art including, for example, can include, but are not limited to, perfluorohexane, a,a,a-trifluorotoluene, pentane, hexane, cyclohexane, methylcyclohexane, decalin [c+t], dioxane, carbon tetrachloride, freon-11, benzene, toluene, triethyl amine, carbon disulfide, diisopropyl ether, diethyl ether (ether), t-butyl methyl ether (MTBE), chloroform, ethyl acetate, 1,2-dimethoxyethane (glyme), 2-methoxyethyl ether (diglyme), tetrahydrofuran (THF), methylene chloride, pyridine (Py), methyl ethyl ketone (MEK), methyl n-amyl ketone (MAK), methyl n-propyl ketone (MPK), acetone, hexamethylphosphoramide, N-methylpyrrolidinone, nitromethane, dimethylformamide, acetonitrile, sulfolane, dimethyl sulfoxide, propylene carbonate, and the like. In certain embodiments, the solvent may be methyl ethyl ketone (MEK) or acetone. The amount of solvent included in the mixtures of various embodiments may be from about 25 wt. % to about 75 wt. % of the total composition, and in certain embodiments, the solvent may be about 30 wt. % to about 50 wt. % of the total composition or any concentration or range encompassed by these example ranges.

In certain embodiments, the reaction mixture may further include a catalyst, such as a Lewis base or a Lewis acid. Lewis bases useful in embodiments include, for example, imidazole, boron trifluoride amine complex, ethyltriphenyl phosphonium chloride, 2-methylimidazole (2MI), 2-phenyl-1H-imidazole (2PZ), 2-ethyl-4-methylimidazole (2E4MI), triphenylphosphine (TPP), and/or 4-dimethylaminopyridine (DMAP). Lewis acids useful in embodiments include metal salt compounds, such as a manganese, iron, cobalt, nickel, copper, or zinc metal salts, for example, zinc caprylate or cobalt caprylate. The amount of the catalyst may be any amount that is effective for use as a catalyst and can, generally, be from about 0.01 wt. % to about 20 wt. % based on the weight of the total composition. In some embodiments, the amount of catalyst may be, about 0.1 wt. % to about 15 wt. %, about 0.5 wt. % to about 10 wt. %, about 1.0 wt. % to about 5 wt. %, or any range or individual concentration encompassed by these example ranges.

The polymer compositions of various embodiments can be used in any application in which a flame retardant polymer is useful. For example, in some embodiments, the polymer compositions of the invention may be used as coatings on plastics, metals, glass, carbon, ceramic, or wood products which can be in a variety of forms, for example as a fiber, woven mat, nonwoven mat, cloth, broadgood, fabric, molding, laminate, foam, extruded shape or the like, and in other embodiments, the polymer compositions of the invention can be used in adhesives or to fabricate sheets, multilayer sheets, free-standing films, multi-layer films, fibers, foams, molded articles, and fiber reinforced composites. In particular embodiments, the compositions of the invention may be used in copper clad laminates (CCL). Such articles may be well-suited for applications requiring flame resistance. The polymer compositions of the invention, may exhibit outstanding flame resistance making these materials useful in applications for the automotive, construction, and electronic sectors that require outstanding fire retardancy, high temperature performance, and melt processability. In addition, these articles may be well suited for a variety of applications as support parts, electrical components, electrical connectors, printed wiring laminated boards, flexible or rigid circuit boards, electrical or electromagnetic housings, electrical or electromagnetic subcomponents and components in consumer products that must meet UL or other standardized fire resistance standards and environmental standards.

In some embodiments, the polymer compositions of the invention may be combined with other components or reinforcing materials. For example, in various embodiments, continuous or chopped glass fibers, carbon black or carbon fibers, ceramic particles or fibers, organic fibers, or other organic materials may be included in the polymers and polymer compositions of the invention. In particular embodiments, continuous or chopped glass fibers, carbon fibers, ceramic fibers, organic fibers, or other organic materials may be combined with the novel compositions containing a polymer resin and hardener containing at least a styrenic component and a phosphonate component of the invention to create a prepreg to prepare laminates. Such laminates may be used to fabricate components such as flexible or rigid laminated circuit boards that can be incorporated into articles of manufacture such as electronic goods such as, for example, televisions, computers, laptop computers, tablet computers, printers, cell phones, video games, DVD players, stereos and other consumer electronics.

The polymer compositions of the invention are generally self-extinguishing, i.e., they stop burning when removed from a flame and any drops produced by melting in a flame stop burning are almost instantly extinguishes and do not readily propagate fire to any surrounding materials. Moreover, these polymer compositions do not evolve noticeable smoke when a flame is applied.

### EXAMPLES

Although the present invention has been described in considerable detail with reference to certain preferred embodiments thereof, other versions are possible. Therefore, the spirit and scope of the appended claims should not be limited to the description and the preferred versions contained within this specification. Various aspects of the present invention will be illustrated with reference to the following non-limiting examples. The following examples are for illustrative purposes only and are not to be construed as limiting the invention in any manner.

### Materials

Styrene-maleic anhydride copolymers (SMA) Xiran C400 and imidized SMA-160121-A, 160121-B, and 160121C were obtained from Polyscope Polymers B.V. The catalyst 2-ethyl-4-methyl-imidazole (2E4MI) was obtained from Alfa Aesar. Epoxy resin Epon 164 was obtained from Hexion. Nofia OL3001 was obtained from FRX Polymers. Melamine Cyanurate MC25 was obtained from JLS Chemical Inc.

### Methods

### Analytical Methods

Glass transition temperatures were measured using Differential Scanning calorimeter (DSC) with the TA Instruments Q2000 model. Samples were heated from 30° C. to 225° C. at a ramp rate of 10° C./min. Phosphorus content was determined using acid digestion, complexation with molybdate, and analysis of phosphomolybdenum blue using photometric quantification (derived from ISO 6878). Nitrogen content was determined using the Kjeldahl method, ISO 5663. The Acid Anhydride Equivalent Weight (AAEW) of the SMA compounds was determined from the acid values of the SMA. The glass transition temperature (Tg), phosphorus and nitrogen contents and Acid Anydride Equivalent Weight (AAEW) of the neat materials are shown in Table I.

TABLE I

| | wt % P | wt % N | Acid value | AAEW | Tg (° C.) |
|---|---|---|---|---|---|
| Nofia OL3001 | 9.8 | 0 | — | — | 92 |
| SMA Xiran C400 | 0 | 0 | 285 | 394 | 130 |
| SMA-160121-A | 0 | 1.5 | 363 | 309 | 134 |
| SMA-160121-B | 0 | 2.0 | 345 | 325 | 133 |
| SMA-160121-C | 0 | 2.5 | 329 | 341 | 135 |
| MC 25 | 0 | 49 | — | — | — |

### Sample Preparation

Formulations containing epoxy resin, the phosphonate oligomer Nofia OL3001, and SMA copolymers shown in Table 1 were prepared by dissolving them in MEK at 60 wt % solids. The mixtures were stirred for 12 hours to fully dissolve into the epoxy resin and 0.2 wt % 2E4MI catalyst was added. After mixing thoroughly, the formulations were poured into a mold of 125 mm by 13 mm by 4 mm. The MEK solvent was evaporated by placing the samples in an oven at 80° C. for 16 hrs. The samples were then cured in an oven at 200° C. for 180 minutes.

### Examples 1-18

Burn results of the 4 mm test bars prepared from formulations containing a range of loadings of the phosphonate oligomer Nofia OL3001 and various combinations of the non-imidized and imidized SMA copolymers are shown in Table II.

TABLE II

| | | Nofia | Xiran | SMA- | SMA- | SMA- | P | N | t1 | t2 | |
|---|---|---|---|---|---|---|---|---|---|---|---|
| | Epon164 | OL3001 | C400 | 1600121- | 1600121- | 1600121- | content | content | max | max | |
| Ex. | (wt %) | (wt %) | (wt %) | A (wt %) | B (wt %) | C (wt %) | (wt %) | (wt %) | sec | sec | drips |
| 1 | 60.8 | 39 | | | | | 3.8 | 0 | 4 | 9 | no |
| 2 | 58.5 | 35 | 6.3 | | | | 3.4 | 0 | 2 | 9 | no |
| 3 | 53.5 | 30 | 16.3 | | | | 2.9 | 0 | 4 | 40 | no |
| 4 | 56.6 | 30 | | 13.2 | | | 2.9 | 0.20 | 5 | >60 | no |
| 5 | 56.2 | 30 | | | 13.6 | | 2.9 | 0.27 | 5 | 5 | no |
| 6 | 56.1 | 30 | | | | 13.7 | 2.9 | 0.34 | 1 | 6 | no |
| 7 | 52.5 | 27.5 | 19.8 | | | | 2.7 | 0 | 2 | >60 | no |
| 8 | 51.9 | 25 | 22.9 | | | | 2.5 | 0 | 10 | >60 | no |
| 9 | 53.4 | 25 | 15.5 | 6.7 | | | 2.5 | 0.10 | 15 | 69 | no |
| 10 | 52.6 | 25 | 8.1 | 13.3 | | | 2.5 | 0.20 | 8 | 80 | no |
| 11 | 54.1 | 25 | 0.7 | 20.0 | | | 2.5 | 0.31 | 10 | 25 | no |
| 12 | 53.6 | 25 | | | 21.2 | | 2.5 | 0.42 | 0 | 9 | no |
| 13 | 53.3 | 25 | | | | 21.5 | 2.5 | 0.54 | 7 | 0 | no |
| 14 | 52.0 | 22 | | | 25.8 | | 2.1 | 0.54 | 12 | >60 | no |
| 15 | 51.6 | 22 | | | | 26.2 | 2.1 | 0.65 | 3 | 8 | no |
| 16 | 49.9 | 19 | | | | 30.9 | 1.8 | 0.77 | 6 | >60 | no |
| 17 | 49.6 | 16 | | 34.2 | | | 1.6 | 0.50 | 23 | >60 | no |
| 18 | 48.3 | 16 | | | | 35.5 | 1.6 | 0.90 | >60 | — | no |

### Comparative Examples A-G

Comparative examples A-G were prepared in the same way as samples in Example 1-18. For comparative example A, regular SMA with no nitrogen content was used. In example B-D, the highest possible loading of each of the imidized SMA's based on AAEW was used as the hardener. For comparative examples E-G, melamine cyanurate was used as the nitrogen synergist instead of imidized SMA. The comparative examples are shown in Table III.

TABLE III

| | Epon | Xiran | SMA- | SMA- | SMA- | Nofia | MC | P | N | t1 | t2 | |
|---|---|---|---|---|---|---|---|---|---|---|---|---|
| | 164 | C400 | 160121- | 160121- | 160121- | OL3001 | content | content | content | max | max | |
| Example | (wt %) | (wt %) | A (wt %) | B (wt %) | C (wt %) | (wt %) | (wt %) | (%) | (%) | sec | sec | drips |
| A | 35.6 | 64.2 | | | | | | 0 | 0 | >60 | — | no |
| B | 41.7 | 0 | 58.1 | | | | | 0 | 0.90 | >60 | — | no |
| C | 40.5 | 0 | | 59.3 | | | | 0 | 1.18 | >60 | — | no |
| D | 39.4 | 0 | | | 60.4 | | | 0 | 1.51 | >60 | — | no |
| E | 55.0 | 14.3 | | | | 30 | 0.55 | 2.9 | 0.27 | 1 | >60 | no |
| F | 49.5 | 27.0 | | | | 22 | 0.86 | 2.5 | 0.42 | >60 | — | no |
| G | 51.6 | 22.3 | | | | 25 | 1.33 | 2.1 | 0.65 | >60 | — | no |

Samples containing Nofia OL3001 and imidized SMA showed better FR performance than Nofia OL3001 and melamine cyanurate MC25 at the same phosphorus and nitrogen content. At 2.9% P and 0.27% N, example 5 had less than 10 second burn times for both t1 and t2, whereas for comparative example E, t2 burned for longer than 60 seconds. Similarly, examples 12 and 15 had less than 10 second burn times for both t1 and t2, whereas comparative examples F and G both had longer than 60 seconds for t1. Overall, the FR efficiency of P-N combinations of OL3001 and reactive imidized SMA were significantly better than for OL3001 and the MC25 added as a filler.

### Glass Transition Temperatures

The glass transition temperatures of selected examples from Table II and comparative examples A-G from Table III are shown in Table IV. Comparative examples A with non-imidized SMA and B with imidized SMA have higher Tg's than examples with Nofia OL3001 but do not pass V0 even at high loadings of imidized SMA without any phosphorus containing material. Increasing the imidized SMA content in formulations containing Nofia OL3001 increased Tg as shown in example 12 versus example 5 and example 18 versus example 15. For comparative examples E-G with melamine cyanurate, higher Tg's were recorded with increasing melamine cyanurate content but as mentioned above, these compositions did not achieve a V0 performance according the UL94 test.

TABLE IV

| | Tg |
|---|---|
| Example | (° C.) |
| 1 | 162 |
| 4 | 156 |
| 5 | 155 |
| 12 | 183 |
| 15 | 167 |
| 18 | 205 |
| Comp A | 195 |
| Comp B | 202 |
| Comp E | 159 |
| Comp F | 172 |
| Comp G | 185 |

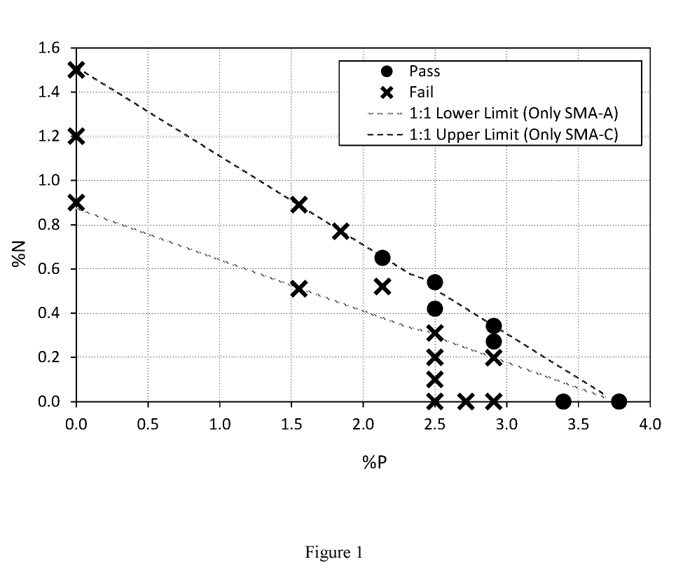

A summary of the vertical burn tests of the range of P-N contents shown in Table II and III is provided in FIG. 1. Pass result refers to t1 and t2 times of <10 sec and fail refers to any samples that did not meet a t1 or t2 burn time of <10 sec. The lower and upper limit refers to the lower and upper nitrogen content that can be achieved in the formulation by using SMA-A with the lowest amount of nitrogen of 1.5 wt % N or SMA-C with the highest amount of nitrogen at 2.5 wt % N.

Thus, combining phosphonate oligomers with regular SMA requires a level of at least about 3.4 wt % of phosphorous in the formulation to obtain a V0 rating at 4 mm. Even combining phosphonate oligomers with imidized SMA will not give a V0 rating if the amount of nitrogen is at about 0.2 wt % or lower. However, surprisingly, at levels of about 0.27 wt % of nitrogen, a V0 rating is obtained at 4 mm with phosphorous levels that are lower than 3 wt % in the final formulation. By further increasing the wt % of nitrogen, it is even possible to reduce the level of phosphorous to about 2.1 wt %. Further reducing the amount of phosphorus does not give a V0 rating, even at relatively high levels of nitrogen, indication an optimum in the composition and combination of nitrogen and phosphorous.

The additional surprising observations are that the good FR performance at lower levels of wt % P in combination with imidized SMA is accompanied with a higher Tg than when no (modified) SMA is added to the formulation. Similarly, it is expected that the Dk and Df of formulations with combinations of imidized SMA and phosphonate oligomers are lower than when formulations are made without (modified) SMA.

### Laminate Preparation

Resin formulations containing the epoxy resin, imidized SMA, phosphonate oligomer and imidazole catalyst were prepared in MEK solvent (55-60% solids). Prepregs were prepared using 7628 glass fabric and b-staging temperatures tested ranging from 130° C. to 180° C. 5-ply laminates were prepared by heating in the press from room temperature to 200° C. at a heating rate of 3° C./min and held at 200° C. for 90 minutes. Pressure range in the press was from 10 to 300 psi.

### Laminate Data

Laminates were prepared using the composition described in example 13 of Table II. Thickness of the laminate was 1.0 mm (7628-5ply) and Tg measured by DSC was 187° C. The laminate has a V0 rating.

1. A composition comprising
a polymer resin;
a styrenic maleic anhydride copolymer, and
a phosphonate oligomer or polymer.

2. The composition of claim 1, wherein the styrenic maleic anhydride copolymer comprises an imidized-styrenic maleic anhydride copolymer.

3. The composition of claim 1, wherein the styrenic maleic anhydride copolymer comprises Formula I:
imidized-SMA can be of general Formula I: 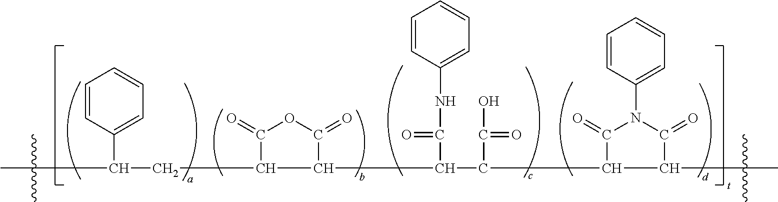
where
a, b, c, and d are each individually integers of 0 to 5, and
t is an integer of 2 to 100.

4. The composition of claim 3, wherein one or more of a, b, or c may be absent.

5. The composition of claim 4, wherein
a is 1 or 2,
b is 0,
c is 0, and
d is 1.

6. The composition of claim 4, wherein
a is 1 or 2,
b is 1,
c is 1, and
d is 1.

7. The composition of claim 4, wherein Monomers b, c, and d may be in any order.

8. The composition of claim 2, wherein the styrene-maleic anhydride copolymer comprises a maleic anhydride group content of about 0% to about 50% (0 to 0.5 mole fraction of maleic anhydride).

9. The composition of claim 2, wherein the styrene-maleic anhydride copolymer comprises from 0% to 100% imidized maleic anhydride groups.

10. The composition of claim 9, wherein the Nitrogen content in the imidized styrenic maleic anhydride copolymer ranges from 0.1 wt % to 10 wt %.

11. The composition of claim 9, wherein the nitrogen content of the styrenic maleic anhydride copolymer ranges from 1.5 wt % to 2.5%.

12. A hardener system comprising at least a styrenic-maleic anhydride component and a phosphonate component.

13. The hardener system of claim 12, wherein the styrenic maleic anhydride copolymer comprises an imidized-styrenic maleic anhydride copolymer.

14. The hardener system of claim 12, wherein the styrenic maleic anhydride copolymer comprises imidized-SMA of general Formula I: 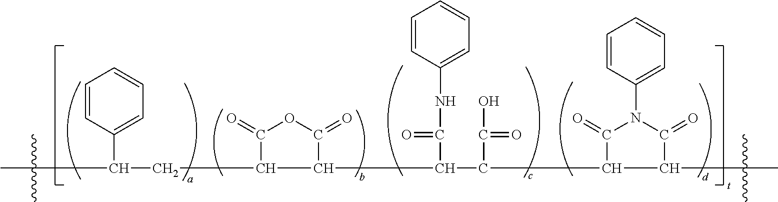
where
a, b, c, and d are each individually integers of 0 to 5, and
t is an integer of 2 to 100.

15. The hardener system of claim 14, wherein one or more of a, b, or c may be absent.

16. The hardener system of claim 14, wherein
a is 1 or 2,
b is 0,
c is 0, and
d is 1.

17. The hardener system of claim 14, wherein
a is 1 or 2,
b is 1,
c is 1, and
d is 1.

18. The hardener system of claim 14, wherein Monomers b, c, and d may be in any order.

19. The hardener system of claim 12, wherein the styrene-maleic anhydride copolymer comprises a maleic anhydride group content of about 0% to about 50% (0 to 0.5 mole fraction of maleic anhydride).

20. The hardener system of claim 12, wherein the styrene-maleic anhydride copolymer comprises from 0% to 100% imidized maleic anhydride groups.

21. The hardener system of claim 9, wherein the Nitrogen content in the imidized styrenic maleic anhydride copolymer ranges from 0.1 wt % to 10 wt %.

22. The hardener system of claim 12, wherein the nitrogen content of the styrenic maleic anhydride copolymer ranges from 1.5 wt % to 2.5%.

23. A hardener system according to claim 12 where the polymer resin is an epoxy resin, a cyanate ester resin, a benzoxazine resin or a polyarylene ether resin.

24. A prepreg comprising of reinforcing material where the composition according to claim 1 is applied to the prepreg and cured.

25. A laminate comprising of one or more prepregs according to claim 24.
